(19) United States
(12) Patent Application Publication
(10) Pub. No.: US 2023/0304549 A1
(43) Pub. Date: Sep. 28, 2023

(54) MULTI-PART BRAKE CALIPER WITH ROTATIONAL JOINT

(71) Applicant: HL MANDO CORPORATION, Pyeongtaek-si (KR)

(72) Inventor: Hatem SHAHIN, Pfaffenhofen (DE)

(21) Appl. No.: 18/125,643

(22) Filed: Mar. 23, 2023

(30) Foreign Application Priority Data
Mar. 23, 2022 (DE) 10 2022 202 829.5

(51) Int. Cl. F16D 65/00

(52) U.S. Cl. CPC F16D 65/0075; F16D 2250/0084; F16D 2055/002

(57) ABSTRACT

The invention relates to a multi-part brake caliper for a vehicle disc brake, the brake caliper comprising: a first part comprising a first portion that is arrangeable at a first side face of a brake disc of the vehicle disc brake; a second part that is formed separately from the first part and comprises a second portion that is arrangeable at a second side face of the brake disc; a middle part connecting the first part and the second part; wherein the middle part is connected to at least one of the first part and second part by a rotational joint.

### CROSS-REFERENCE TO RELATED APPLICATION

This application is based on and claims priority under 35 U.S.C. § 119 to German Patent Application No. 102022202829.5, filed on Mar. 23, 2022 in the German Patent and Trade Mark Office, the disclosures of which are incorporated herein by reference.

### TECHNICAL FIELD

The invention relates to a multi-part brake caliper for a vehicle disc brake and to a method for producing the same. The vehicle to be braked by the vehicle disc brake may in particular be a road vehicle, such as a car, a truck or a bus.

### BACKGROUND

Brake calipers are typically used to support and carry at least one brake pad that is movable relative to a braked member. The braked member may in particular be a brake disc of a vehicle disc brake. The brake caliper may also be referred to as a caliper frame. The brake caliper may receive a brake piston and/or may house at least part of a brake actuating mechanism that may e.g. be electric or hydraulic.

Typically, the brake caliper receives at least part of the brake disc, such as a radially outer section. The brake caliper may face opposite sides of the brake disc. This way, a pair of brake pads that are each supported by the brake caliper can be arranged on opposite sides of the brake disc. In a generally known manner, the brake pads can thus clamp the brake disc in between them.

Each brake pad is arranged at one of a first and second inner face of the brake caliper and specifically at a so called finger side or a piston side thereof. Said inner faces and said sides lie on opposite sides of the brake disc and/or are spaced apart from one another along a rotational axis of the braked member.

A prior art example of a brake caliper can be found in KR 2009 007718 A.

During brake activation, large forces act on the brake caliper. The brake caliper may thus elastically deform or, put differently, elastically deflect. In existing brake calipers this can be accompanied with a number of disadvantages. For example, an uneven wear of the brake pads and specifically of their brake linings may occur. This may result in further problems, such as the generation of drag torque or noise. Furthermore, a hydraulic volume absorbed by the brake caliper and more specifically by a hydraulic chamber comprised by the brake caliper may increase as a result of the deformation. This additional brake fluid volume absorption is generally undesired for brake performance and/or safety reasons.

Further disadvantages of existing brake calipers result from their production. Typically, brake calipers are designed as metallic one-piece casted or shaped parts. This puts limitations on their design which, amongst others, restricts the possibility to improve their elastic deformation characteristics.

### SUMMARY

It is an object of this disclosure to provide a brake caliper and a method for producing the same that limit at least some of the above disadvantages.

This object is solved by the subject matter according to the independent claims. Advantageous embodiments are defined in this description and in the dependent claims.

Accordingly, a multi-part brake caliper for a vehicle disc brake is disclosed, the brake caliper comprising:
a first part comprising a first portion (e.g. a first inner face) that is arrangeable at a first side face of a brake disc of the vehicle disc brake;
a second part that is formed separately from (i.e. independently of) the first part and comprises a second portion (e.g. a second inner face) that is arrangeable at a second side face of the brake disc;
a middle part connecting the first part and the second part;
   wherein the middle part is connected to at least one of the first part and second part by a rotational joint, the rotational joint comprising:
a rounded portion provided at one of the middle part and the respectively connected one of the first part and second part (i.e. the at least one of the first part and second part connected to the middle part by the rotational joint); and
a receiving portion receiving the rounded portion and provided at the respective other of the middle part and the respectively connected one of the first part and second part.

For example, when the middle part is connected to the first part, the rounded portion is provided at either the middle part or the first part and the receiving portion is provided a the respective other of the middle part and first part at which the rounded portion is not provided. The same applies to a case of connecting the middle part and the second part by a rotational joint.

The first part and that second part may be configured as a separate members or, put differently, as separate pieces. They may be produced separately and e.g. with different production methods. They may be assembled and in particular mechanically connected by the middle part during an assembly process, thereby forming the brake caliper.

The middle part may likewise be configured as a member or as a piece that is separate from the first part and/or the second part. It may be produced by a production method that is different from a production method used for producing at least one of the first part and second part.

The first part, the middle part and the second part may define a sequence of parts along the rotational axis. The middle part may be arranged in between the first part and the second part, in particular when viewed along the rotational axis. There may be no axial overlaps between the first part and the second part. Rather, the first part and the second part may be spaced apart from one another by the middle part and/or by an axial distance of several centimetres, e.g. at least 10 cm.

The first part may define an outermost axial end portion of the brake caliper when viewed in a first direction of the rotation axis. The second part may define a different outermost axial end portion of the brake caliper when viewed in an opposite second direction of the rotation axis. In other words, the first part and the second part may define opposite outermost axial end portions of the brake caliper. The first part, the second part and the middle part may each be one-piece members, in particular integral members having a homogeneous material composition. Alternatively, any of the first part, the second part in the middle part may be a multi-piece member, wherein said multiple pieces are in particular fixed or joined to one another to provide a coherently movable composite part. Of course, the brake caliper may comprise any combination of any of the first part, the second part and middle part being provided as a one-piece member or as a multi-piece member.

An axial overlap between the first part and the middle part and/or between the second part and the middle part may be limited to less than 30% and preferably less than 10% of an axial dimension of at least one of the respective parts (i.e. of at least one of the first part and the middle part and/or of at least one of the second part and the middle part). This may in particular concern an axial overlap resulting from forming the rotational joint.

Receiving the rounded portion in the receiving portion may include producing a form fit between these members. Additionally or alternatively, a force fit may be produced. The rotational joint may allow for a relative movement of the rounded portion and receiving portion about at least one rotation axis and in at least one direction about said axis. The rotational joint may not include any axial or linear degrees of freedom.

Providing one portion with a rounded shape (i.e., the rounded portion) may allow for an accurate definition of the at least one rotation axis. Also, the rotational movements can thus be reliably guided over a long lifetime of the brake caliper.

The rounded portion may be insertable into the receiving portion, e.g. under elastic deformation of one of these members. It may be inserted axially and/or via an opening provided in or adjacent to the receiving portion. For example, insertion may take place along an axis extending at an angle and in particular orthogonally to the rotation axis of the brake disc of the vehicle disc brake. Said insertion axis may e.g. run in parallel to the side faces of the brake disc. The receiving portion may comprise an opening that is accessible by the rounded portion when moving it along said axis.

According to one configuration, the receiving portion is formed by different parts (e.g. different halves). These may be detached and/or removed from one another so that the rounded portion is receivable in between them. Afterwards, the parts may be fixed relative to one another while still receiving the rounded part.

By designing the brake caliper as a respective multi-part member and compared to providing known one-piece configurations, it is possible to increase the degrees of freedom for designing each of the first part, the second part and the middle part. For example, each of the first part, the second part of the middle part may be produced independently of any of the respective other parts. This provides freedom e.g. with respect to a selection of production methods as well as a selection of materials, dimensions or shapes. In consequence, the single parts may be optimized with respect to the overall deformation characteristics of the brake caliper and/or with respect to their individual production costs.

Other advantages may be achieved by the rotational joint. For example, this rotational joint may alter the deformation characteristics of the brake caliper in a desired manner. In particular, it may allow for defining an elastic joint or a joint with a defined and/or limited rotation range (e.g. a restricted angular range of rotation) to compensate for caliper deformations occurring under load. For example, the rotational joint may provide a defined freedom of movement/orientation, said movement preferably counteracting an undesired movement that would otherwise occur under load. This may in particular concern rotation movements of the first and/or second portions of the first and second parts, respectively. This way, a relative orientation between said portions can be maintained even under load.

In more detail, a preferred deformation characteristic may be marked by the inner faces of the first part and the second part which face the brake disc essentially maintaining their relative orientation to one another even under high brake loads. For example, they may maintain an essentially parallel orientation to one another. This e.g. helps to limit irregular brake pad wear and irregular heat generation of the brake pads connected to said parts as well as any of the other drawbacks mentioned in the above introductory portion.

For example, it has been determined that as a result of the elastic deformation of existing brake calipers a significant deformation or deflection of the inner faces of the brake caliper facing the brake disc and typically carrying the brake pads may occur. As a result, an axial distance between said faces may increase and may locally vary. For example, the faces may slightly tilt with respect to one another and/or with respect to the rotational axis of the brake disc. They may thus assume a non-parallel orientation and/or may generally become slanted, in particular at different angles compared to one another. This may result in an uneven widening of a gap between the faces and/or in uneven axial local deflection and displacement across and within each face. This may e.g. promote uneven wear of the brake pads. This may at least partially be prevented by solution disclosed herein.

According to a preferred embodiment, the first part and the second part are spaced apart from one another by the middle part. This may in particular concern the first and the second part being axially spaced apart from one another. Differently put, the middle part may be axially arranged between said first and second part, so that these remain at an axial distance to one another.

Additionally or alternatively, the middle part may be the only part connecting the first part and second part.

In one example, the middle part is arrangeable so as to extend along the rotational axis of the brake disc. In particular, it may span an axial gap between the first part and the second part and/or span across (and above) the brake disc from one side to another. In this context, it may lie opposite to an outer circumferential face of the brake disc. The extension of the middle part may in particular include (or, put differently, overlap with) an axial position of the first side face of the brake disc and/or an axial position of the second side face of the brake disc.

Generally, the rotational joint may be positioned in an angled corner portion of the caliper at which the caliper's extension e.g. changes from along the rotation axis to along a side face of the brake disc. An axial position of the rotational joint may thus equally overlap with the axial position (or may be located at a greater axial distance to the brake disc than to the axial position) of a respectively adjacent first portion of the first part or second portion of the second part.

According to a further embodiment, the middle part is integrally formed with or is mechanically (and/or non-movably) fixed to the respective other of the first and second part to which it is not connected by the rotational joint. This may limit the required assembly steps and still allows for at least one of the first part and second part to be independently produced and/or optimized. The rotational joint and/or an optional mechanical fixation of the middle part to the first part and/or the second part may be positioned at or near an axial position of an inner face of the respective first part and second part, said face facing the brake disc.

In one example, at least one of the first and second part comprises a cavity for receiving a brake piston. The respective other of the first and second part may also comprise such a cavity or may be free of such a cavity. Any of the first and second part and in particular both may each support and/or carry at least one brake pad. For example, they may carry and/or guide a brake pad during an axial displacement thereof when braking.

According to a further example, the middle part may comprise at least one recess or at least one through-hole, in particular in a side facing away from the brake disc. Said side may be equivalent to a radially outer side of the middle part. The recess may define a radial indentation. The through-hole may extend radially, e.g. from a radially outer side facing away from the brake disc to a radially inner side. The recess and/or through-hole may be elongated, e.g. axially or circumferentially.

By means of the recess or through-hole, weight savings can be achieved. In this context, the increased degree of freedom, e.g. in terms of shapes and dimensions that is achieved by forming the middle part separately from at least one of the first part and second part is particularly beneficial. More precisely, this increases respective degrees of freedom also with regard to the design of the respective recesses and through-holes.

In one example, at least one of the first part, the second part and the middle part is made from or comprises a material that is different from a material of a respective other of the first part, the second part and the middle part. Nonetheless, all of these parts may be made from or comprise a metallic material. Accordingly, at least two different materials may be present and/or may be distributed between said parts. This underlines the increased flexibility in designing the brake caliper compared to existing one-piece configurations.

Generally, at least one the first part, the second and the middle part may be a non-casted part. For example, it may be shaped part or a part produced by layering and/or welding several material sheets above one another.

According to one embodiment, the rounded portion comprises (or is formed as) at least a spherical segment, in particular wherein the rounded portion comprises an at least half-spherical segment. Alternatively, the rounded portion is spherical. For example, it may be ball-shaped and e.g. attached to the middle part by a web portion or a connecting bolt.

Generally, the receiving portion may be hollow or at least partially confine a space in which the rounded portion is arrangeable. The rounded portion (in particular an outer surface thereof) may contact the receiving portion (in particular an inner surface thereof). Alternatively, it may contact an elastic member acting as an intermediate member and arranged in between the rounded portion and receiving portion.

In one example, the receiving portion is shaped correspondingly to the rounded portion. For example, its inner surface may be curved according to a curvature of the rounded portion (in particular an outer surface thereof). This enables a particularly tight connection and/or contact between these portions.

According to another aspect, the rounded portion is integrally formed with the middle part (e.g. in case the middle part is casted or forged) or the rounded portion is fixed to the middle part. In the latter case, e.g. a screw connection may be formed between the rounded portion and the middle part.

Generally, the rounded portion may form a protrusion (e.g. protruding from the part at which it is provided). It may protrude towards and into the receiving portion comprised by the respective other part. The receiving portion, on the other hand, may form an inwardly extending cavity or space that e.g. extends from an outer surface of the part comprising the receiving portion into an inner volume of said part.

A rotation axis of the rotational joint may extend along at least one of the first portion and the second portion. For example, it may extend substantially in parallel to or at an angle of less than 200 to at least one of said portions. In other words, the rotation axis may extend at an angle and in particular orthogonally to a plane that comprises the brake disc's rotation axis.

Generally, the rotation axis of the rotational joint may extend at an angle to a rotation axis of a brake disc of the vehicle disc brake.

By providing a respectively oriented rotation axis, a rotational degree of freedom can be defined that is suitable for effectively counteracting the above-discussed undesired elastic deformations under brake load.

In one example, a rotation about the rotational joint is limited or, put differently, blocked in at least one direction. For example, this may be achieved by a contact between the middle part and the respectively connected first part and second part. The limitation may be present already when not under load, i.e. in a non-deflected state of the brake caliper.

Alternatively, it may be present at the latest once 50% of an expected maximum load are present. Accordingly, there may be an initial play allowing for a slight movement in the respective direction (e.g. not more than 50 or 101, before a further movement in said direction is blocked. A play or movement in the respective opposite rotation direction may be larger, e.g. at least twice or three times as large (e.g. more than 100 or more than 201.

Additionally or alternatively, a rotation about the rotational joint may be enabled in at least one direction by a clearance (in particular a larger one than in another and possibly limited direction, see above) between the middle part and the respectively connected one of the first part and the second part. This direction may be different from a direction in which a rotation is optionally blocked. That is, the rotation may be limited or blocked in one direction according to any of the examples disclosed herein, while it may be allowed in the other direction due to an enlarged clearance.

As a general feature, the respectively connected one of the first and second part may assume a defined orientation or defined rest position when the brake caliper is not under load. For example, gravitation forces or elastic resetting forces (e.g. of an optional elastic member disclosed herein) may cause the respectively connected one of the first and second part to assume said orientation or position.

The middle part may have a side face facing the respectively connected one of the first part and the second part. The rounded portion may be provided at said side face. The side face may be inclined. For example, it may be tilted relative to the respectively connected one of the first part and second part, in particular towards thereto. This may include an orientation of said face in the direction of the respectively connected one of the first part and second part compared to a (hypothetical) parallel orientation to these parts.

By providing a tilted or inclined side face, clearances for allowing or limiting rotations in defined directions can be set in a particularly reliable manner.

According to a further embodiment, the brake caliper may comprise an elastic member that is configured to elastically support the rounded portion when said rounded portion is received in the receiving portion. For example, the elastic member may be a ring or bushing. It may be arranged in between the rounded portion and receiving portion. It may be inserted into the receiving portion prior to or together with the rounded portion. It may deform when rotating the rounded portion relative to the receiving portion and/or it may generally deform when the caliper is under load.

The elastic member may be made of a more elastic material compared to the first part, the second part and/or the middle part (e.g. as defined by an E-modulus of the respective materials). It may be made of a non-metallic material, but e.g. of a rubber or plastic material instead, or of a more elastic metal than the first, second and middle part of the brake caliper 10.

In a further aspect, the elastic member may be shaped correspondingly to the rounded portion. It may surround at least part of the rounded portion. For example, it may define a hollow portion or cavity in which at least part of the rounded portion is received. The elastic member receiving the rounded portion may, on the other hand, be received in the receiving portion together with the rounded portion.

The rotational joint may comprise a part-spherical rounded portion and may have a compact size. Alternatively, it may be elongated. For example, it may have a hinge-type configuration with a rounded, yet elongated portion received in a similarly elongated receiving portion.

The invention also concerns a method for producing a brake caliper for a vehicle disc brake, the brake caliper comprising:
a first part comprising a first portion that is arrangeable at a first side face of a brake disc of the vehicle disc brake;
a second part that is formed separately from the first part and comprises a second portion that is arrangeable at a second side face of the disc brake;
a middle part for connecting the first part and the second part;
   the method comprising:
connecting the middle part to at least one of the first part and the second part by arranging at least one rounded portion in at least one receiving portion and thereby forming at least one rotational joint, wherein the rounded portion is provided at one of the middle part and the respectively connected one of the first part and the second part and the receiving portion is provided at the respective other of the middle part and respectively connected one of the first part and the second part.

Note that in case the middle part is integrally formed with one of the first part and second part, connecting it to the respective other of the first part and second part via the rotational joint may suffice to provide a mechanical connection between the first part and the second part. If provided separately from both of the first part and the second part, the middle part may be connected to both of these parts to provide the mechanical connection therebetween, wherein at least one of these connections includes forming the rotational joint.

According to one embodiment, the method further comprises:
producing at least one of the first part, the second part and the middle part by a production method that is different from a production method of the respective other parts.

The production methods may be generically or categorically different. For example, they may relate to different main groups as classified in the German Industrial Norm (DIN) 8580 (i.e. casting, shaping, separating, joining, coating). Generally, at least one of the parts may be produced by a production method that is different from casting.

### BRIEF DESCRIPTION OF DRAWINGS

Embodiments of the invention are discussed in the following with respect to the attached schematic figures. Similar features may be marked with same reference signs throughout the figures.

FIG. 1 is a schematic sectional view of a vehicle disc brake according to a prior art solution.

FIG. 2 is a schematic sectional view of the brake caliper of the vehicle disc brake of FIG. 1 under load.

FIG. 3 is a schematic side view of a brake caliper according to an embodiment of the invention in a dissembled state.

FIG. 4 is view of the brake caliper of FIG. 3 in an assembled state.

FIG. 5 is a schematic side view of a brake caliper according to another embodiment of the invention in a dissembled state.

FIG. 6 is view of the brake caliper of FIG. 5 in an assembled state.

FIG. 7 is a detail view of the brake caliper of FIG. 6 when not under load.

FIG. 8 is a detail view of the brake caliper of FIG. 7 when under load.

FIG. 9 is a schematic side view of a brake caliper according to an embodiment of the invention in a dissembled state.

FIG. 10 is a view of the brake caliper of FIG. 9 in an assembled state.

FIG. 11 is a schematic side view of a brake caliper according to an embodiment of the invention in a dissembled state.

FIG. 12 is view of the brake caliper of FIG. 10 in an assembled state.

FIG. 13 is a partial side view of a brake caliper according to another embodiment of the invention when not under load.

FIG. 14 is a detail view of the brake caliper of FIG. 13 when under load.

FIG. 15 is another detail view of the brake caliper of FIG. 13 when under load.

FIG. 16 is schematic side view of a brake caliper according to another embodiment of the invention.

FIG. 17 is top view of the brake caliper of FIG. 16.

FIG. 18 is schematic sectional top view of a brake caliper according to another embodiment of the invention.

### DETAILED DESCRIPTION

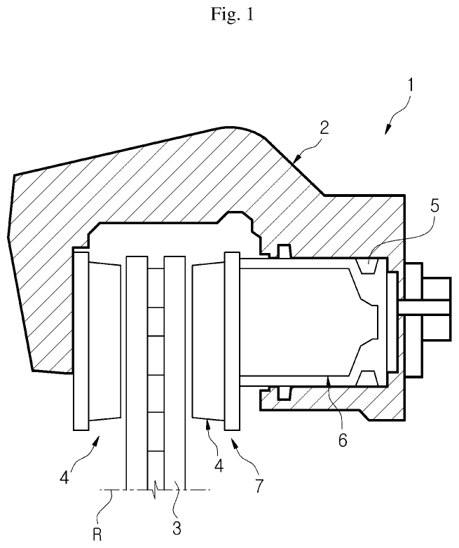

FIG. 1 shows a prior art vehicle disc brake 1. The vehicle disc brake 1 comprises a brake caliper 2 that is configured as a one-piece casted member. The brake caliper 2 spans across a brake disc 3 that rotates about a rotation axis R (note: only an upper half of the brake disc 3 is depicted in FIG. 1).

The caliper 2 carries two brake pads 4. Specifically, it carries one brake pad 4 at a first side face of the brake disc 3 (e.g. the left side face in FIG. 1) and another brake pad 4 at a second side face of the brake disc 3 (e.g. the right side face in FIG. 1). For doing so, the caliper 2 comprises a first portion (or finger side) arranged adjacent said first side face and a second portion (or piston side) arranged adjacent said second side face. These portions confine a space or recess 7 for receiving the brake disc 3.

The brake caliper 2 also comprises a cavity 5 for receiving a brake piston 6 and defining a hydraulic chamber. The brake piston 6 is hydraulically displaceable to contact and press one of the brake pads 4 against the brake disc 3. In a known floating caliper manner, this also forces the opposite second brake pad 4 into contact with the brake disc 3, so that the brake disc 3 is clamped in between the brake pads 4 and thus braked. Upon releasing the hydraulic pressure in the cavity 5, this clamping is released.

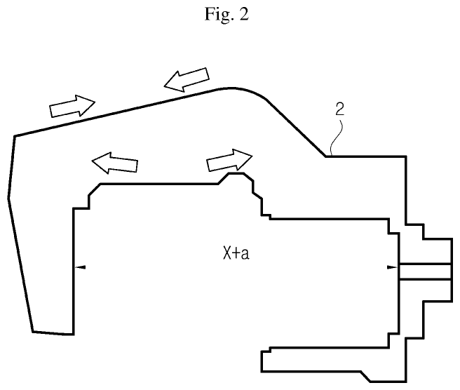

FIG. 2 indicates main concentrations of mechanical stresses occurring in the brake caliper 2 during braking, i.e. when the brake caliper 2 is under load. The region spanning the brake disc 3 and comprised by the below discussed middle part is focused on. At a radially upper side, pressure forces occur (see the upper arrows indicating an orientation of main stresses and pointing towards one another). At a radially lower or inner side, tension forces occur (see the lower arrows indicating an orientation of main stresses and pointing away from one another).

This uneven distribution of stresses leads to an elastic bending of the caliper 2. Accordingly, an axial distance X between the first portion and second portion of the brake caliper 2 that are provided on different sides of the brake caliper 2 may increase. Specifically, it increases from the initial distance X to X+a, with a being larger than zero. Importantly, in radial direction, the value of the distance increase a may vary, thus leading to the first and second portion changing their relative orientation. This elastic deformation behaviour of the brake caliper under load is accompanied with the above discussed disadvantages.

The brake calipers according to the below discussed embodiments of the invention may be arranged similarly relative to a brake disc as the brake caliper 1 of FIG. 1. Also, they may carry brake pads in a similar manner in order to arrange them on different sides of the brake disc. Even though not specifically illustrated in the below embodiments, the respective second part in each case comprises a brake actuating mechanism, e.g. identical to the piston 6 received the cavity 5 of FIG. 1.

On the other hand, in each of the embodiments the brake actuating mechanism could alternatively be provided in the first part or both of the first part and second part could each comprise at least one respective cavity. Also, there may generally be no such cavity 5 or at least no cavity 5 defining a hydraulic chamber. Instead, a vehicle disc brake comprising the brake caliper may e.g. be actuated electrically.

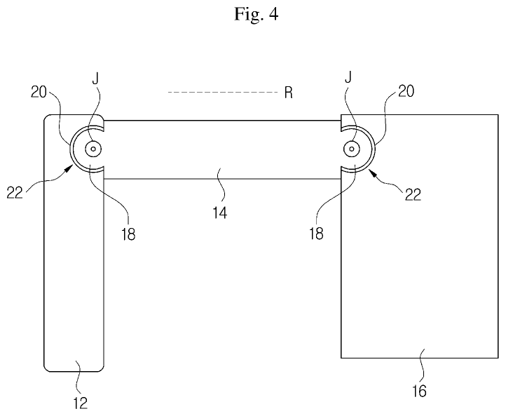

FIG. 2 shows components of a brake caliper 10 according to an embodiment of the invention in a non-assembled state. The brake caliper 2 comprises a first part 12, a middle part 14 and a second part 16. When viewed along a schematically indicated rotation axis R, these parts (especially in the assembled state, see FIG. 4) form an axial succession with the middle part 14 being axially arranged in between the first part 12 and the second part 16.

The first part 12 comprises a first portion 13 (e.g. an inner side face) that is arrangeable to face a first side face of a brake disc (not illustrated) and the second part 16 comprises a second portion 17 (e.g. an inner side face) that is configured to face in opposite second side face of the brake disc (not illustrated). The first portion 13 and the second portion 17 thus face one another. They confine at least part of a recess or space in which the brake disc can be received similar to what is depicted in FIG. 1. Also, at each of the first portion 13 and second portion 17, a brake pad can be arranged similar to what is shown in FIG. 1.

The middle part 14 comprises a rounded portion 18 at both of its axial ends. The rounded portion 18 is ball-shaped and integrally formed with the middle part 14 (e.g. by casting or forging). The rounded portions 18 axially protrude with respect to an axial centre of the middle part 14.

The first part 12 and the second part 16 both comprise a receiving portion 20. Each receiving portion 20 is formed as a recess or cavity. Its shape and, more precisely, the shape of its inner surface matches a shape of an outer surface of the rounded portions 18. As indicated in FIG. 4, this way each receiving portion 20 is configured to receive and at least partially surround one of the rounded portions 18 to define a form fit therewith. Also, a force fit may be produced to arrange the first part 12, the middle part 14 and the second 16 in a defined manner relative to one another and to maintain said relative orientation.

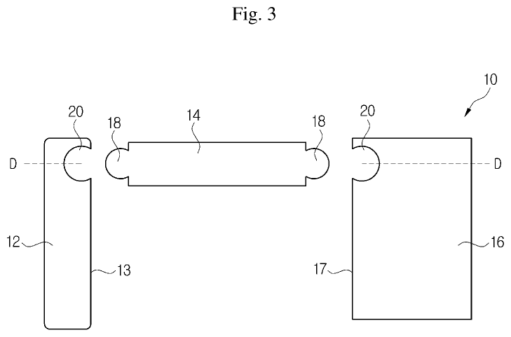

Arranging the rounded portions 18 in the receiving portions 20 may include temporarily elastically widening the receiving portions 20. Alternatively, the receiving portion 20 may be defined by at least two sub-parts comprised by the first part 12 and second part 16 that may be temporarily detached from one another to receive the rounded portions 18 in between them. An optional divisional plane D for dividing the first part 12 and the second 16 extends orthogonally to the image plane of FIG. 3 and is indicated with a dotted line. In general, once received in the receiving portion 20, the rounded portion 18 cannot easily be removed or pulled out of the receiving portion 20 during normal brake operation.

By receiving a rounded portion 18 in a receiving portion 20 a rotational joint 22 is defined. Its (e.g. main) rotation axis J extends orthogonally to the image plane and through a centre of the rounded portion 20.

The rotational joints 22 are positioned so as to overlap or be axially adjacent to with an axial position of first portion 13 of the first part 14 and second portion 17 of the second part 16. They are positioned in regions in which the shape of the caliper 10 changes from extending along a side face of the brake disc 12 to spanning across the brake disc 12. Put differently, the rotational joints 22 are provided in corner portions or angled portions of the caliper 10. These corner or angled portions are each provided at and/or each comprise an axial outer edge of the middle part 16. Note that this position of the rotational joints 22 in or at an inlet portion is not limited to the depicted embodiment or its further specifics, but may be a general feature of any embodiment disclosed herein.

In FIG. 4, it can be seen that the middle part 14 and the respectively connected first part 12 and second part 16 contact one another in edge regions surrounding the rounded portions 18 and receiving portions 20, respectively. This contact limits an amount of rotation about the rotational axes J. The contact is formed at both of a radially upper and lower side of the rounded portion 18 (e.g. radially above and below of the centre of the rounded portion 18).

A first advantage of the embodiment according to FIGS. 3 and 4 is the configuration of the brake caliper 2 is a multipart member. More precisely, the first part 12, the middle part 14 and second part 16 the can be produced independently from one another and even by generically different production methods. This allows for an individual optimisation of each part, e.g. in terms of costs and/or rigidity without being severely restricted by boundary conditions concerning the respective other parts 12, 14, 16. For example, the first part 12 may be a non-casted part (e.g. produced by metallic shaping), whereas the second part 16 may be a metal-cast part. The middle part 14 may comprise a layer of sheet metals or may be welded from different parts. On the other hand, even if producing each part 12, 14, 16 with the generically same production method (e.g. casting) they can still be individually optimized (e.g. in terms of shapes or dimensions) which can bring about improvements compared to existing one-piece designs.

Another advantage concerns of the elastic deformation behaviour. The mechanical stresses occurring under load are generally similar to FIG. 2. By way of the rotational joints 22, a rotational degree of freedom is introduced which, however, is limited by the contact between the middle part 14 and each of the first part 12 and second part 16. Yet, given that this contact is formed on both a radially upper and lower side of the rounded portion 18, and due to the expected extents of the mechanical stresses at the radially upper end lower side of the middle part 14 (see FIG. 2) and the resulting deformations, it has been determined that a slight rotation about the rotational axis J can occur that may limit the increase in axial distance marked a in FIG. 2. Also, the rotation may at least dissipate some of the mechanical energy associated with the stresses, thus further limiting the increase in axial distance a.

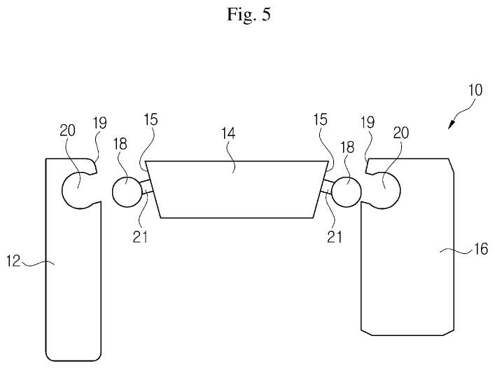

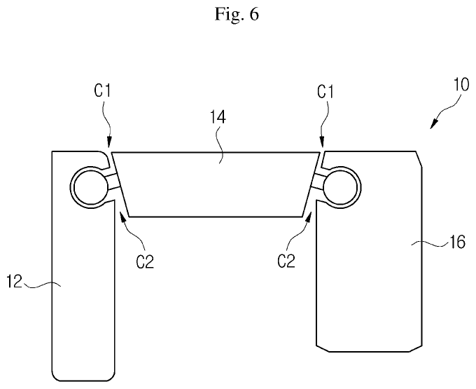

FIGS. 5 and 6 show a brake caliper 10 according to further embodiment. FIG. 5 shows a disassembled state, whereas FIG. 6 shows an assembled state. The caliper 10 again comprises a first part 12 a middle part 14 and a second part 16 that are arranged and oriented relative to one another in the same manner as in the first embodiment. A difference compared to the first embodiment concerns the design of the middle part 14. Specifically, the side faces 15 of said middle part 14 which face the respectively adjacent first part 12 and second part 16 are inclined. More precisely, they are tilted towards the respectively adjacent first part 12 and second part 16.

At the side faces 15, the rounded portions 18 are provided. Merely as an example, these are configured as spheres that are connected to the side faces 15 by a web section 21. The first part 12 and the second part 16 again comprise receiving portions 20 shaped similar to the rounded portions 18. The inclination of the side face 15 is chosen to define different radially upper and lower axial clearances C1 and C2 indicated in FIG. 6. Additionally or alternatively, this difference in clearances C1, C2 can be defined by adjusting the (local) axial width and/or the (local) inclination of inner faces 19 of the first part 12 and the second part 16 that face the respectively inclined side face 15 of the middle part 14.

As visible in FIG. 6, the radially upper clearance C1 is smaller than the radially lower clearances C2 (e.g. is at most half as large). This means that an angular range of a possible clockwise rotation of the first part 12 towards the middle part 14 is smaller (i.e. is limited to the angular range of the clearance C1) than a rotation in a counter-clockwise direction that corresponds to the angular range of the clearances C2. With regard to the second part 16, a counter-clockwise rotation towards the middle part 14 is equally more limited (i.e. defined by the smaller clearance C1) compared to an opposite clockwise rotation.

In reaction to the mechanical stresses occurring under load and explained with respect to FIG. 2, this means that the increase a in the axial distance X and in particular its local variations can be limited. This is because a tilting movement of the first and second portions 13, 17 away from one another is restricted.

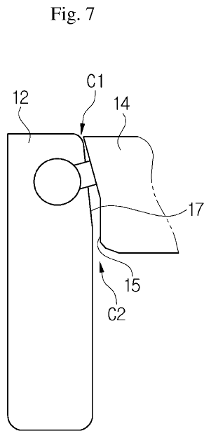

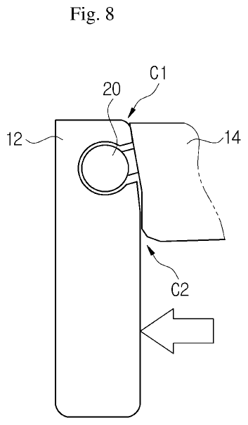

FIGS. 7 and 8 show an alternative configuration of the embodiment of FIGS. 5 and 6. These Figures only depict the first part 12 and part of the middle part 14. Yet, an identical configuration may be provided between the middle part 14 and the second part 16. The shape and/or inclination of the side face 15 and/or the opposite inner faces 19 of the first part 12 are chosen so that the radially upper clearances C1 is zero. This already occurs when not under load. The radially lower clearances C2, on the other hand, is present already when not under load and e.g. amounts to not more than 2 mm, e.g. between 0.2 and 0.5 mm. Note that the clearance C2 of FIGS. 5 and 6 may have similar dimensions.

FIG. 8 shows the brake caliper 10 of FIG. 7 when under load. Load is caused by a reaction force indicated by an arrow and resulting from pressing the brake pad against the brake disc during braking (not illustrated). It is shown that the lower clearance C2 is significantly reduced and may e.g. be reduced to 0, while the upper clearance C1 remains zero at an increased contact pressure. This results from the tension forces occurring in the radially lower section of the middle part 14 (see FIG. 2). Reducing the clearance C2 accordingly may be supported by the rotational joint 20 which supports a respective deformation of the radially lower part of the middle part 14 under load. At the same time, this means that the mechanical stresses occurring under load are at least partially dissipated by said rotational movement, thereby limiting an increase in the axial distance a (see FIG. 2).

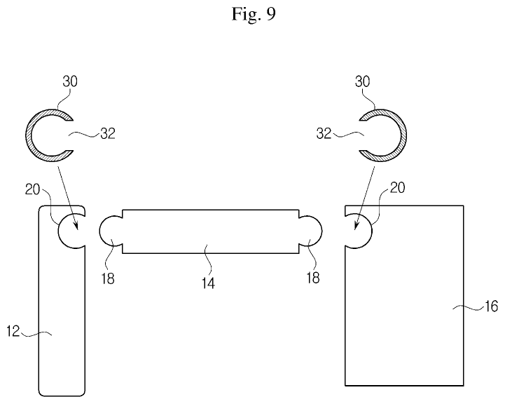

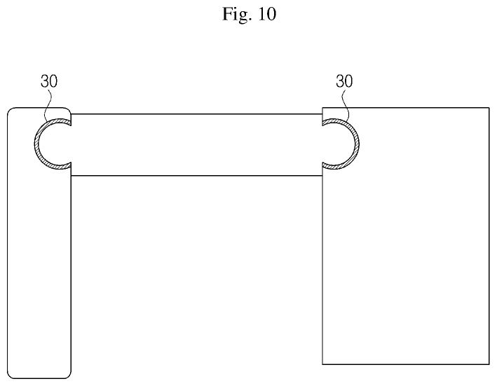

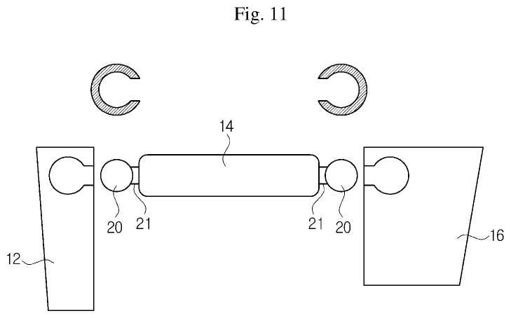

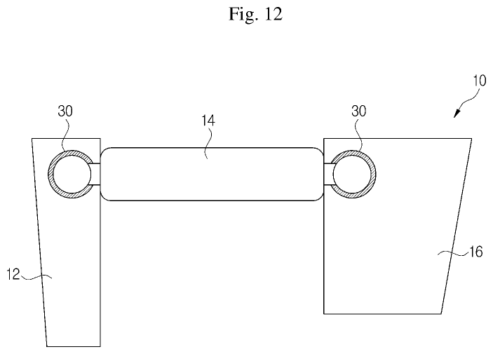

FIGS. 9-12 show embodiments that are comparable to those of FIGS. 3-4, but further include an elastic member 30 in each of the rotational joints 22. FIGS. 9 and 10 correspond to the embodiment of FIGS. 3 and 4 in which the middle part 14 is integrally formed with its rounded portions 18. FIGS. 11 and 12 show a different configuration in which the rounded portions are mechanically connected to the middle part 14, e.g. by a screw connection forming a web section 21.

The elastic members 30 are formed as elastic rings or as at least part-spherical members having an opening 32 in order to receive the rounded portions 18.

The elastic members 30, as depicted in FIGS. 10 and 12, are arranged in between the rounded portions 18 and the receiving portions 20, thereby acting as elastic intermediate members. The rounded portions 18 and receiving portions do not directly contact one another, but may be separated from one another by a respective elastic member 30.

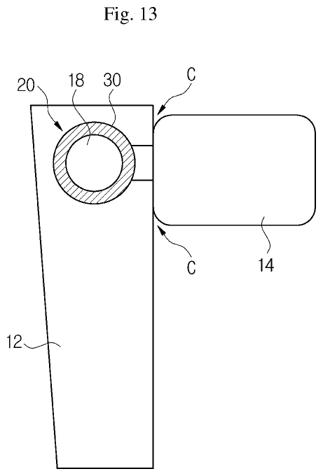

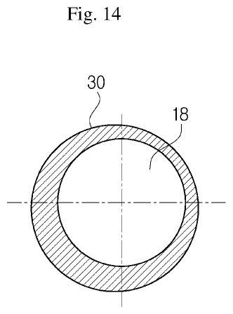

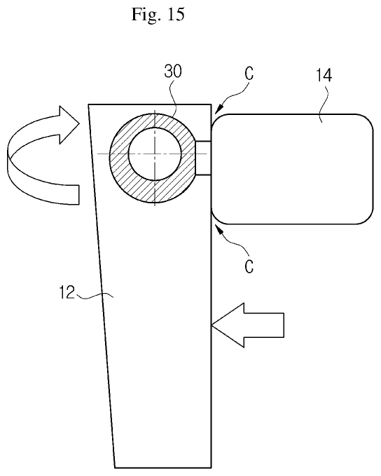

FIGS. 13-15 show a deformation of the elastic member 30 under load. The figures are based on the configuration of FIG. 12. FIG. 13 shows a part of FIG. 12 in a state where the brake caliper 12 is not under (mechanical) load. FIG. 15 is a view similar to FIG. 13 with the brake caliper 12 being under load. FIG. 14 is an enlarged view of the elastic member in the loaded state of FIG. 15. In FIG. 13, the direct contact between the middle part 14 and first part 12 is shown. A clearance C is zero, even when not under load.

In FIG. 15, the lower arrow marks a reaction force occurring during braking. The upper curved arrow indicates that the first part 12 may in reaction slightly rotate about the rotational joint 22 relative to the middle part 14 while deforming the elastic member 30. As shown in FIG. 14, this may result in the rounded portion 18 no longer being concentrically arranged in the receiving portion (as previously the case in the non-braking state). Also, this may result in a contact pressure between the first part 12 and middle part 14 increasing at the upper reference sign C and decreasing at the lower reference sign C.

The deformation of the elastic member 30 is an additional means to dissipate at least part of the mechanical stresses. Also, it may act as a dampening element to limit vibrations. Further, its deformation may at least partially compensate for deformations of the first part 12 and second part 14, thereby limiting an increase a of the axial distance (or at least its local variations) as explained with respect to FIG. 2.

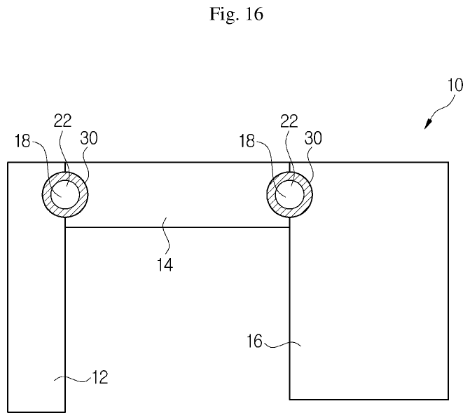

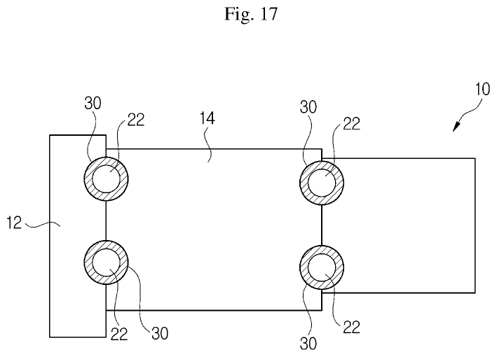

FIGS. 16 (top view) and 17 (side view) indicate possible distributions of rotational joints 22 within a brake caliper 10 according to a further embodiment. The middle part 14 is fixed to at least one (and in the shown case to both) of the first part 12 and second part 16 by a plurality of rotational joints 22. Each rotational joint 22 comprises one spherical rounded member 18. Optionally, each rotational joint 22 may comprise an elastic member 30 of the above-explained type. FIGS. 16 and 17 are highly schematic and maily serve to illustrate positions of the rotational joints 22. It should be understood that the rotational joints 22 may not be visible from outside and housed with the parts 12, 14, 16 of the brake caliper 10.

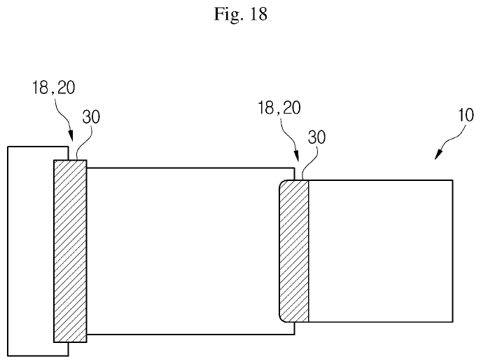

FIG. 18 shows a top view of a brake caliper 10 according to an alternative embodiment. In this case, the elastic member 30 is elongated. A horizontal sectional plane is positioned so that this elastic member 30 is visible. Specifically, it is formed with a C-shaped cross-section (see FIG. 9) and extending along the width of the brake caliper 10. The (non-depicted) receiving portion 20 may also extend with a similar cross-section along said width and receive the elastic member 30. The rounded portion 18 that is obstructed by the elastic member 30 may define a hinge with a similar cross-section shape as depicted in e.g. FIG. 3 and may be elongated along the width of the brake caliper 10 as well.

What is claimed is:

1. A multi-part brake caliper for a vehicle disc brake, the brake caliper comprising:
a first part comprising a first portion that is arrangeable at a first side face of a brake disc of the vehicle disc brake;
a second part that is formed separately from the first part and comprises a second portion that is arrangeable at a second side face of the brake disc;
a middle part connecting the first part and the second part;
wherein the middle part is connected to at least one of the first part and second part by a rotational joint, the rotational joint comprising:
a rounded portion provided at one of the middle part and the respectively connected one of the first part and second part; and
a receiving portion receiving the rounded portion and provided at the respective other of the middle part and the respectively connected one of the first part and second part.

2. The brake caliper according to claim 1,
wherein the rounded portion comprises at least a spherical segment, in particular wherein the rounded portion comprises an at least half-spherical segment.

3. The brake caliper according to claim 1,
wherein the receiving portion is shaped correspondingly to the rounded portion.

4. The brake caliper according to claim 1,
wherein the rounded portion is integrally formed with the middle part or wherein the rounded portion is fixed to the middle part.

5. The brake caliper according to claim 1,
wherein a rotation axis of the rotational joint extends along at least one of the first portion and the second portion and/or wherein the rotation axis of the rotational joint extends at an angle to a rotation axis of a brake disc of the vehicle disc brake.

6. The brake caliper according to claim 1,
wherein a rotation about the rotational joint is limited in at least one direction by a contact between the middle part and the respectively connected first part and second part; and/or
wherein a rotation about the rotational joint is enabled in at least one direction by a clearance between the middle part and the respectively connected first part and second part.

7. The brake caliper according to claim 1,
wherein the middle part has a side face facing the respectively connected one of the first part and second part, the rounded portion being provided at said side face and said side face being inclined.

8. The brake caliper according to claim 1,
further comprising an elastic member that is configured to elastically support the rounded portion when said rounded portion in the receiving portion.

9. The brake caliper according to claim 8,
wherein the elastic member is shaped correspondingly to the rounded portion and surrounds at least part of the rounded portion.

10. A method for producing a brake caliper for a vehicle disc brake, the brake caliper comprising:
a first part comprising a first portion that is arrangeable at a first side face of a brake disc of the vehicle disc brake;
a second part that is formed separately from the first part and comprises a second portion that is arrangeable at a second side face of the disc brake;
a middle part for connecting the first part and the second part;
the method comprising:
connecting the middle part to at least one of the first part and the second part by arranging at least one rounded portion in at least one receiving portion and thereby forming at least one rotational joint,
wherein the rounded portion is provided at one of the middle part and the respectively connected one of the first part and the second part and the receiving portion is provided at the respective other of the middle part and respectively connected one of the first part and the second part.

11. The method of claim 10,
further comprising:
producing at least one of the first part, the second part and the middle part by a production method that is different from a production method of the respective other parts.
